(19) United States
(12) Patent Application Publication
(10) Pub. No.: US 2025/0135470 A1
(43) Pub. Date: May 1, 2025

(54) CENTRIFUGE

(71) Applicant: Andreas Hettich GmbH & Co. KG, Tuttlingen (DE)

(72) Inventors: Matthias HORNEK, Tuttlingen (DE); Andreas HOELDERLE, Braeunlingen-Doeggingen (DE); Eugen KIZMANN, Villingen-Schwenningen (DE); Klaus-Guenter EBERLE, Tuttlingen (DE)

(21) Appl. No.: 18/684,177

(22) PCT Filed: Aug. 16, 2022
(86) PCT No.: PCT/EP2022/072820

§ 371 Date: Feb. 15, 2024

(30) Foreign Application Priority Data
Aug. 16, 2021 (DE) 10 2021 121 259.6

(51) Int. Cl. B04B 9/08

(52) U.S. Cl. CPC B04B 9/08; B04B 2009/085

(57) ABSTRACT

A centrifuge comprises: a drive shaft rotatable about an axis, an adapter connected thereto or forms part thereof; an axially removable rotor mounted on adapter; a quick-release fastener for fixing rotor relative to adapter in removal direction and releasable; an abutment connected to adapter; a locking bearing connected to rotor; locking element as part of quick-release fastener to fix rotor relative to adapter and drive shaft and effective between locking bearing and abutment. Quick-release fastener has actuating element where locking element is operatively connected and being movable between unlocking and locking position linearly in parallel to axis; locking element moves linearly relative to adapter when actuating element moves and is movable at angle (α) to axis between locking and unlocking position, and locking bearing is oriented at different angle (β). Angles (α, β) are measured clockwise from axis starting from actuating element's side and between 0° and 90°.

The invention relates to a centrifuge of the type specified in the preamble of claim 1.

Centrifuges with a detachable rotor are already known which have a device for axially locking and non-rotationally connecting the rotor to the drive shaft itself or to an adapter arranged on the drive shaft, for which no complex assembly and no special tools are required for locking.

A centrifuge is known from DE 10 2018 114 289 A1. This centrifuge has a drive shaft that can rotate about an axis of rotation. An adapter is non-rotationally connected to the drive shaft. The adapter can be detached from the drive shaft as required. Alternatively, the adapter can also be part of the drive shaft. A rotor that can be removed axially in a removal direction is provided on the adapter, which rotor is connected to the adapter via a quick-release fastener that can be operated with one hand only and that is effective between the rotor and the adapter. By means of the quick-release fastener, the rotor can be fixed relative to the adapter, and thus also relative to the drive shaft, in the removal direction, and can be released, if necessary, for example for loading the rotor with samples outside the centrifuge or for installing a different rotor for other sample containers in the centrifuge. The adapter is provided with an abutment and the rotor is fitted with a locking bearing. Moreover, at least one locking element is provided acting as part of the quick-release fastener, which, when activated, fixes the rotor relative to the adapter and thus to the drive shaft and is effective between the locking bearing of the rotor and the abutment of the drive shaft. In addition, the quick-release fastener has an actuating element that can be used to move the locking elements out of an unlocking position and into a locking position thereof, and vice versa. The locking element is operatively connected to the actuating element in such a way that the actuating element is mounted so as to be movable linearly, in particular parallel, to the axis of rotation of the drive shaft between an unlocking position and a locking position thereof. The locking element performs a linear movement relative to the adapter when the actuating element is moved between the unlocking position and the locking position. In order to prevent jamming and ensure trouble-free rotor replacement over a long period of time, this design requires a very high level of manufacturing precision. This high manufacturing precision ensures secure, backlash-free locking.

A centrifuge is also known from DE 10 2014 008 219 A1. In this case, however, the locking elements are rotated from an unlocking position to a locking position about an axis that is parallel to the axis of rotation of the drive shaft. A disadvantage here is that the locking elements swing out. If the system is subject to tolerances, in particular a height tolerance in an axial direction, the locking elements will no longer abut against the locking bearing in a planar manner, but only in certain points. This results in a high level of material stress in some areas. Another problem encountered with this design is that the locking elements are exposed to high strains during rotation. Because of the horizontal arrangement of the locking elements and the fact that they can be moved in the horizontal plane, the centrifugal forces act almost unhindered on the locking elements. In many cases, the locking elements become jammed with the rotor so that it is no longer possible to release the quick-release fastener and thus the locking elements. As a result, the rotor can no longer be removed easily from the adapter or the drive shaft.

A generic centrifuge is known from DE 10 2014 002 126 A1. This centrifuge has a quick-release fastener for a rotor, which is provided with a bearing axle on which the locking element is mounted so as to be axially displaceable. A spring pushes the locking element into its extended position, the locking position. One locking surface of the locking bearing is aligned horizontally, at an angle of 90° between the axis of rotation and the locking surface. The bearing axle on which the locking element is displaced is at an angle of between 95° and 120°, preferably of between 100° and 110°, in particular of between 100° and 107°. The locking element is shaped in such a way that its downward-facing front part, which is associated with the locking surface of the rotor, is moved horizontally during unlocking and locking. The disadvantage of this design is that the forces generated during centrifugation can cause the locking element to jam. This then blocks the quick-release fastener which can no longer be operated as a result. In addition, the surfaces of the locking element, the bearing axle and the locking surface must be precisely machined. The shape of the locking elements is very complex. A compensation of tolerances is not possible. Moreover, if the rotor and the adapter are not manufactured precisely, they may be mounted with play.

It is the object of the invention to further develop a centrifuge of the type specified in the preamble of claim 1 in such a way that, while avoiding the disadvantages mentioned, the locking elements allow for backlash-free locking between the rotor and the adapter, as well as ensure compensation of production-related tolerances.

This object is accomplished for a centrifuge by the characterizing features of claim 1 in conjunction with the features of its preamble.

The invention is based on the realization that by arranging the locking element at a first angle to the axis of rotation of the drive shaft and by forming the locking bearing of the rotor at a second angle to the axis of rotation, the production-related tolerances of the rotor, the adapter and the drive shaft can be compensated and the rotor can still be locked without play relative to the adapter and the drive shaft. As a result, the locking element is more or less in radial contact with the locking bearing, for example.

The invention therefore provides for the locking element to be movable between the locking position and the unlocking position linearly at a first angle to the axis of rotation. The locking bearing is oriented at a second angle to the axis of rotation, which is different from the first angle. Here, the first and second angles are mainly measured clockwise from the axis of rotation of the drive shaft, starting from the side of the actuating element, and are between 0° and 90°. The different formation of the two angles prevents the locking element from jamming and also ensures easy release of the quick-release fastener from the locking position into the unlocking position. This is also a simple way of creating the conditions for compensating for manufacturing tolerances of the drive shaft, adapter and rotor, particularly in the direction of the axis of rotation. For example, backlash-free locking is then possible despite existing manufacturing tolerances, as the locking element engages more or less in the locking bearing depending on the respective tolerance.

Preferably, the first angle is in a range of between 20° and 75° and the second angle is in a range of between 10° and 70°. Among other things, the first angle is used to set the force that acts on the locking element during operation of the centrifuge, i.e. during rotation. The greater the angle, the greater the centrifugal forces acting on the locking element. The second angle is used to set the extended position of the locking element to compensate for tolerances.

The first angle is greater than the second angle. The smaller the second angle, the smaller the difference in the position of the locking element at a certain tolerance compared to a design without any tolerance in the locking position. The greater the second angle, the greater the difference in the position of the locking element at a certain tolerance compared to a design without any tolerance in the locking position.

Preferably, the locking bearing forms a surface that extends as far as the adapter in the locking position, with the surface of the locking bearing at the adapter in the locking position having a height offset relative to the locking element protruding from the adapter, so that the locking element rests against the locking bearing in the locking position at a radial distance from the adapter.

The height offset is greater than the maximum possible manufacturing tolerance of the

adjacent surfaces of the adapter and the rotor in a direction parallel to the axis of rotation. This prevents a situation from occurring in which the locking element is no longer able to enter sufficiently into the locking bearing in a certain tolerance situation when the rotor is locked with the adapter or, in the worst case, it is even blocked and not able to enter into the locking bearing at all.

In particular, the actuating element is designed as a cylindrical pin. In its lower area, the actuating element has a receptacle for the one or plural locking element(s). This thus allows easy transfer of the movement of the actuating element to the locking elements.

In one embodiment of the invention, the actuating element has lateral U-shaped recesses for the locking elements, which enable a relative movement of the actuating element with respect to the respective locking element between a locking position and an unlocking position thereof.

The U-shaped recess can be designed as an angled bore in the transverse area, which angled bore extends at a first angle to the axis of rotation.

The possibilities of force transmission from a spring to the actuating element and to the locking elements are increased by providing a pressure plate on the side of the actuating element associated with the drive shaft, with a first contact surface for the respective locking element being provided on one side of the pressure plate, and a second contact surface for a spring being provided on the other side of the pressure plate. The locking elements can slide along the first contact surface as they move between the locking position and the unlocking position to compensate for their position relative to the actuating element.

Here, the first contact surface of the pressure plate for the respective locking element can be aligned at an angle that is perpendicular to the first angle.

Depending on the design of the locking element, it can be in point contact, in particular in two points, or in linear or flat contact with the locking bearing.

In one embodiment of the invention, the adapter has a guide surface for the locking element which is inclined at the first angle. This guide surface enables the locking element to be retracted and extended linearly with respect to the adapter, i.e. the locking element to be moved between the locking position and the unlocking position thereof.

The abutment can also be part of the adapter and, in particular, can also be aligned at the first angle. In particular, the guide surface and the abutment can be identical.

To enable easy operation and, above all, to prevent the rotor from being unintentionally released from the adapter and thus from the drive shaft, the actuating element and/or the locking element is spring-loaded in the direction of the locking position.

The security against unintentional unlocking can be increased by providing a plurality of locking elements. In addition, the forces that occur during operation will thus be distributed across the multiple locking elements, which reduces failure due to wear or breakage of the locking elements. At least two locking elements are advantageous, three locking elements are preferred. Each locking element is identical to the other, which reduces manufacturing costs.

In order to prevent imbalances caused by the quick-release fastener from occurring in the first place, the locking elements are arranged evenly spaced from one another.

In one embodiment of the invention, the locking element is designed as an elongated pin which is almost completely cylindrical, particularly in its basic shape. Simple, cost-effective and reliable production of the locking elements is ensured by turning with high dimensional accuracy within tight tolerances. This also allows the corresponding surfaces in the adapter and rotor to be produced easily and cost-effectively.

To prevent the locking element from rotating when moving from the locking position to

the unlocking position and vice versa, the locking element has recesses that interact with projections on the adapter to provide anti-rotation protection.

In one embodiment of the invention, the front end of the locking element has a bevel which rests against the locking bearing in the locking position. This results in two support points per locking element, which halves the force at the support point for the locking element. This further reduces the risk of jamming, and the bevel can also be used to adjust the position of the locking element for certain manufacturing tolerances.

In a further embodiment of the invention, the locking element is provided with a chamfer at its front end, which is designed so that it runs parallel to the locking bearing in the locking position, i.e. with the rotor mounted on the adapter. The locking element can be designed as a simple turned part. Linear contact is achieved thereby. This is another very simple way of reducing the risk of jamming.

Preferably, the bevel is identical to the conical surface of the locking bearing. This ensures that the locking elements rest flat against the locking bearing with different height tolerances, which further reduces the risk of jamming. The conical surfaces of the locking bearing can be produced within tight tolerances by simple, cost-effective and reliable production by turning with high dimensional accuracy.

Preferably, the locking element is mounted in the adapter in such a way that the longitudinal axis of the locking element intersects the axis of rotation.

In one embodiment of the invention, three locking elements are provided, which results in a good distribution of the forces occurring during operation and creates a secure connection between the adapter and the rotor.

The design according to the invention results in the locking elements being guided in the adapter. The guidance of the locking elements is adjusted within narrow tolerances, so that jamming is easily avoided.

Additional advantages, features and possible applications of the present invention will be apparent from the description which follows, in which reference is made to the embodiments illustrated in the drawings.

Throughout the description, the claims and the drawings, those terms and associated reference signs are used as are stated in the list of reference signs below. In the drawings,

FIG. 1 is a perspective view of the rotor, mounted on the adapter and the drive shaft, of a centrifuge with drive motor, but with the safety vessel, housing and other functional parts of a laboratory centrifuge according to one embodiment of the invention not being shown;

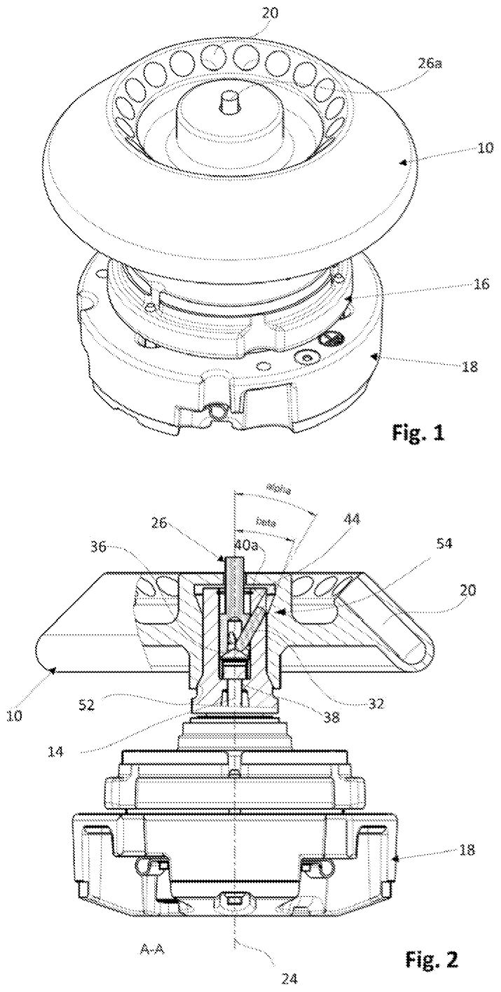

FIG. 2 is a side view of FIG. 1 with a partial section through the rotor, with the locking element in its unlocking position;

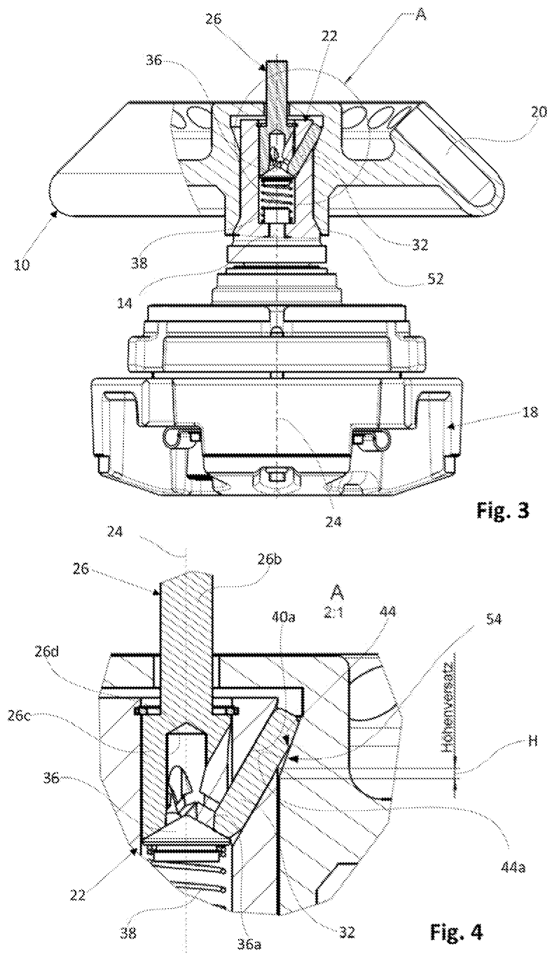

FIG. 3 is a side view of FIG. 1 with a partial section through the rotor, with the locking element in its locking position;

FIG. 4 is an enlarged detail of the marked circular area A of FIG. 3;

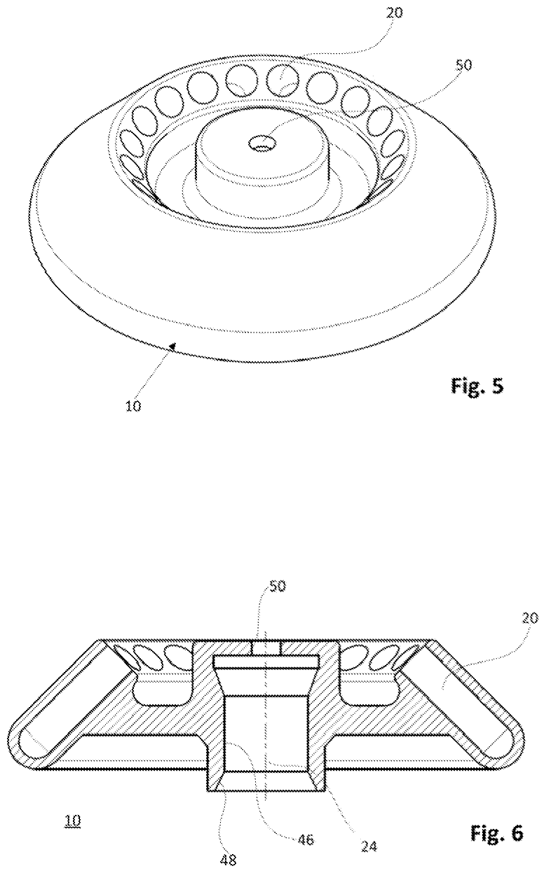

FIG. 5 is a perspective view of the rotor removed from the centrifuge;

FIG. 6 is a sectional view of the rotor of FIG. 5;

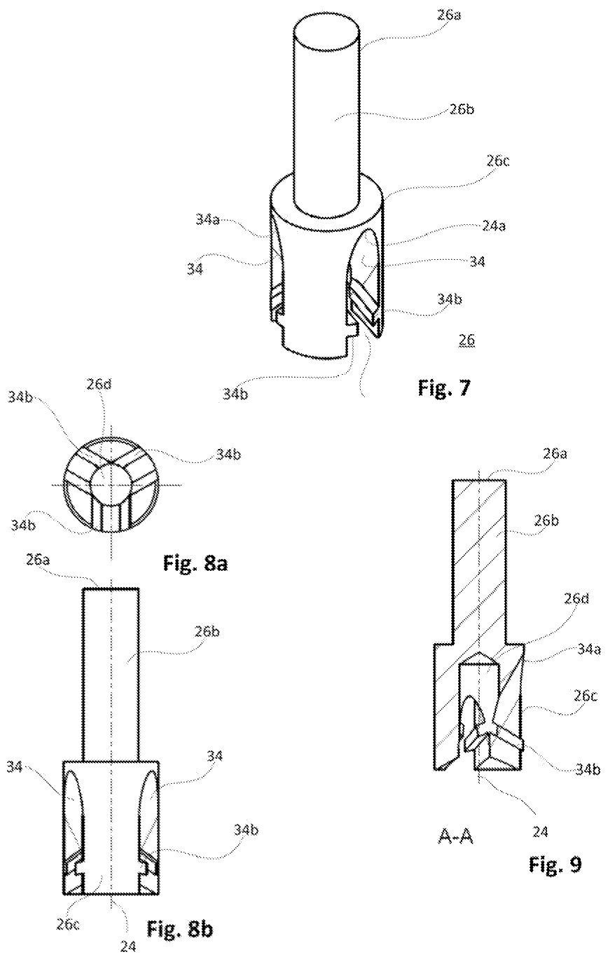

FIG. 7 is a perspective view of the actuating element;

FIG. 8a is a view of the actuating element from below;

FIG. 8b is a side view of the actuating element;

FIG. 9 is a side sectional view of the actuating element;

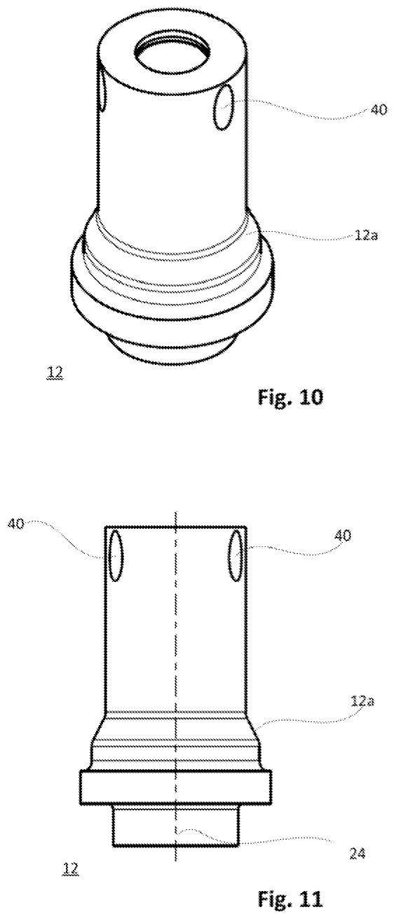

FIG. 10 is a perspective view of the adapter;

FIG. 11 is a side view of the adapter;

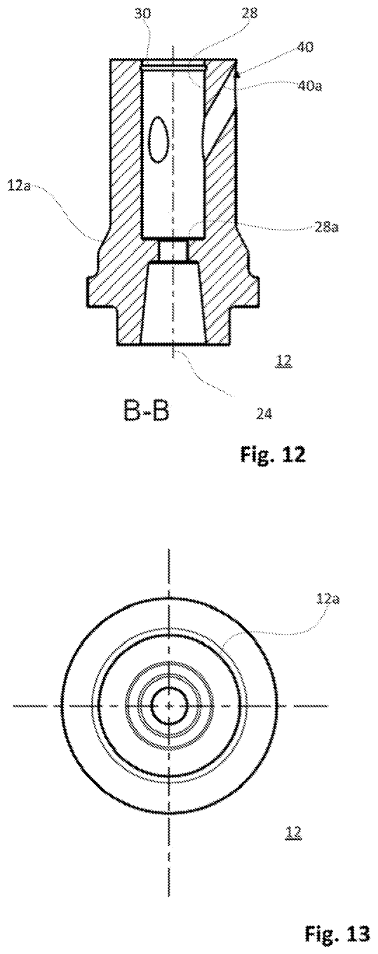

FIG. 12 is a side sectional view of the adapter;

FIG. 13 is a top view of the adapter;

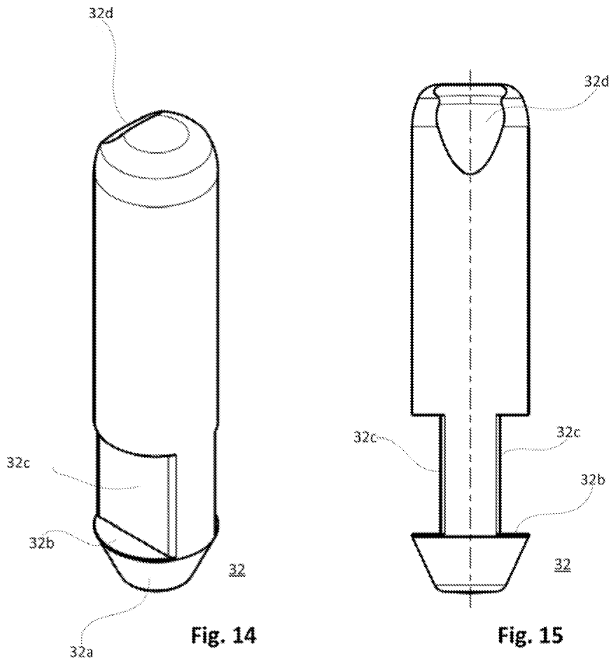

FIG. 14 is a perspective view of the locking element;

FIG. 15 is a first side view of the locking element;

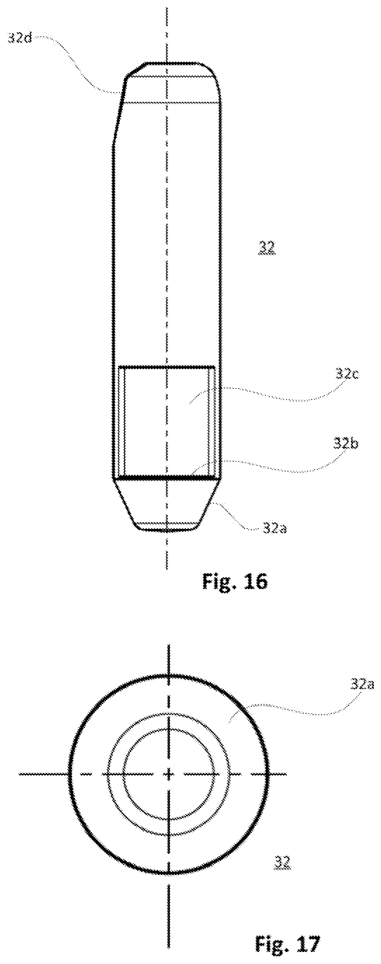

FIG. 16 is a second side view of the locking element, which is rotated by 90° as compared to the view of FIG. 15;

FIG. 17 is a view of the locking element from below;

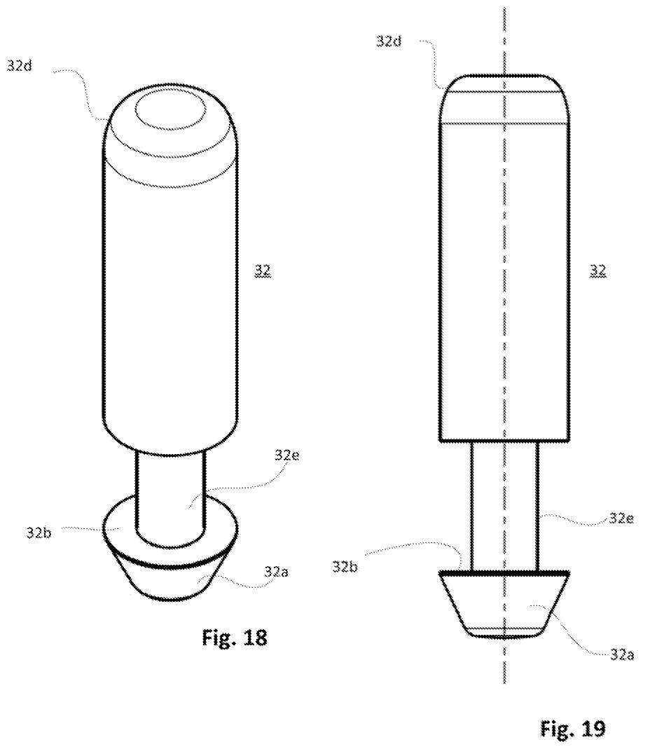

FIG. 18 is a perspective view of another embodiment of the locking element, and

FIG. 19 is a side view of the locking element of FIG. 18.

Illustrated in FIGS. 1 to 17 are different views of a first embodiment of a laboratory centrifuge. The centrifuge comprises a rotor 10, which is mounted on a drive shaft 14 via an adapter 12. The drive motor 18 drives the rotor 10 via the drive shaft 14 and the adapter 12.

The adapter 12 is non-rotationally connected to the drive shaft 14 and fixed in the axial direction relative to the drive shaft 14.

The rotor 10 is a conventional rotor 10 with inclined sample container receptacles 20 for sample containers (not shown here).

The rotor 10 is connected to the adapter 12 via a quick-release fastener 22. The quick-release fastener 22 fixes the rotor 10 on the adapter 12 against rotation in an axial direction and in both directions about an axis of rotation 24 of the drive shaft 14.

Because of the quick-release fastener 22, no tools are required to remove the rotor 10 from the adapter 12 or to install the rotor 10 in the centrifuge, namely on the adapter 12 mounted on the drive shaft 14.

The quick-release fastener 22 has an actuating element 26, which protrudes from the top of the adapter 12 and the rotor 10 and forms a push button 26a. For this purpose, the adapter 12 is provided with a bore 28 arranged concentrically to the axis of rotation 24 of the drive shaft 14, in which a stop ring 30 is inserted at the upper end of the adapter. The axial movement of the actuating element 26 is limited upwards by the stop ring 30, see FIG. 2 to FIG. 4.

The upper area 26b of the actuating element 26 is pin-shaped and cylindrical. This is followed by a widened, lower cylindrical area 26c, which has a concentric, downwardly open bore 26d, see FIG. 7 to FIG. 9. The lower area 26c has three U-shaped lateral recesses 34, which are associated with the three locking elements 32. The transverse area 34a of the U-shaped recess 34 is designed as an inclined bore. The angle of the inclined bore corresponds to a first angle α. A projection 34b is provided on each side in the lower area of the U-shaped recess 34. Both lateral projections 34b engage from each side in a recess 32b of the locking element 32, see FIG. 14 and FIG. 15. The recess 32b of the locking element 32 is designed so as to allow a relative movement between the locking element 32 and the actuating element 26, with the projections 34b and the recess 32b serving as a guide for this relative movement.

Underneath the actuating element 26 a pressure plate 36 is located and makes contact, which has a conical surface 36a on the side facing the bore 26d, against which the locking elements 32 rest in their lower region. The conical surface 36a, i.e. the cone formed thereby, runs perpendicular to the longitudinal axis of the locking element 32 and thus perpendicular to the first angle α. During the process, the locking elements 32 move along the conical surface from the locking position to the unlocking position and vice versa. On the side remote from the locking element 32, a spring 38 bears against a second support surface of the pressure plate 36 remote from the first support surface, which spring 38 is supported on a shoulder 28a in the bore 28 of the adapter 12 and biases the actuating element 26 and the locking elements 32 upwards towards a locking position.

The adapter 12 is designed as a turned part, i.e. it is rotationally symmetrical. The adapter 12 is provided with three inclined bores 40, which bores 40 are made into the adapter 12 at a first angle α and are equidistant from one another. Inserted through each bore 40 is a locking element 32, which is cylindrical and which is adapted to the bore 40 so as to be linearly displaceable along a longitudinal axis 42 of the bore 40 (which latter is aligned at the first angle α) between an unlocking position, see FIG. 2, and a locking position thereof, see FIG. 3. The inner surface of the bore 40 in the adapter 12 serves as a guide surface for this purpose. The guide surface also forms an abutment 40a for the locking element 32 in the locking position.

In the lower area, the adapter 12 is provided with a conical portion on the outside, which serves as a support 12a for the rotor 10. The support 12a acts to fix the rotor 10 downwards in an axial direction.

The locking element 32, see FIGS. 14 to 17, is designed as a cylindrical pin. The lower end of the locking element is provided with a cone 32a. A recess 32b is formed in the cone 32a on each side of the locking element 32, resulting in a rectangular flat shape which forms two mutually parallel guide surfaces 32c.

The upper area of the locking element 32 is rounded and has an upper conical clamping surface 32d on the side which is oriented at 90° to the guide surfaces 32c, which surface 32d comes to rest flush with an associated surface of a locking bearing 44 of the rotor 10. The remaining upper area of the locking element 32 is rounded. The basic shape of the locking element is cylindrical and rotationally symmetrical.

An alternative locking element 32 is seen in FIG. 18 and FIG. 19. In this case, a rotationally symmetrical recess 32e concentric to the longitudinal axis of the locking element is made, for example by screw-cutting, in the connection to the cone 32b. The height of the recess 32e corresponds to the height of the recess 32b.

As can be seen in FIG. 2 in particular, the locking bearing 44 runs at a second angle β. The first angle α is greater than the second angle β. In addition, the surface 44a of the locking bearing 44, see FIG. 4, extends to below the bore 40 in the adapter 12. This results in a height offset H, see FIG. 4, which can be used to compensate for the manufacturing tolerances-height tolerance, mainly caused by two cones 52, 54, i.e. a first cone 52 between rotor 10 and adapter 12 and a second cone 54 between adapter 12 and rotor 10—along the axis of rotation 24 of the drive shaft 14. The locking bearing 44 is a conical surface 44a, which is aligned at the second angle β. In any case, the height offset H is greater than the maximum possible manufacturing tolerance of the adjacent surfaces of the drive shaft 14, the adapter and the rotor 10 in a direction parallel to the axis of rotation. Because of the height offset H, the locking element 32 comes into contact with the locking bearing 44 in the locking position at a radial distance from the adapter 12.

Both the first angle α, at which, for example, the guide surface and the abutment 40a of

the bore 40 are aligned, and the second angle β, at which the locking bearing 44 is aligned, are measured clockwise starting from the top of the axis of rotation 24 to the abutment 40a and the locking bearing 44. In this case, the first angle α is greater than the second angle β. The first angle α is between 0° and 90°, in particular 30°. The second angle β is also between 0° and 90°, in particular 20°.

The locking elements 32 are arranged at an even distance from each other. In this respect, the bores 40, but also the U-shaped recesses 34, are arranged at the same distance from each other. Each locking element 32 is associated with a U-shaped recess 34 and a bore 40 in the adapter 12. The two lateral projections 34b of a U-shaped recess 34 engage in the recess 32b of the locking element 32.

The recess 32c cooperates with the lateral projections 34b in the U-shaped recess 34 so as to provide anti-rotation protection for the locking element 32. As a result, the locking element 32 will not rotate as it moves linearly from its unlocking position to its locking position.

The rotor, see FIG. 5 and FIG. 6, has a rotor bore 46 which is arranged concentrically to the axis of rotation 24 and which has a conical area 48 at its free end. The conical area 48 is the counter bearing on the rotor side for the support 12a of the adapter 12. The rotor bore 46 is open at the bottom to allow the rotor 10 to be placed on the adapter 12 and to allow the adapter 12 to engage in the rotor 10. A through-hole 50 is provided at the top concentric to the axis of rotation 24, from which the actuating element 26 with its push button 26a protrudes when the rotor 10 is mounted. Otherwise, the rotor 10 is provided in a conventional manner with the sample container receptacles 20 for sample containers (not shown here).

Preferably, a set of different rotors 10 is provided, which can accommodate different sample container shapes. However, the area of the rotor bore 46 with the through bore 50 and the locking bearing 44 always has the same structure.

Now, if the rotor 10 is to be removed from the centrifuge, i.e. lifted from the adapter 12 and the drive shaft 14 in a removal direction, namely upwards, the push button 26a of the actuating element 26 is pressed downwards from its locking position, see FIG. 3 and FIG. 4, into its unlocking position, see FIG. 2. This causes the actuating element 26 and the pressure plate 36, and hence also the locking elements 32, to move linearly downwards against the force of the spring 38. Each locking element 32 is moved linearly downwards at an angle α until the locking element 32 is completely positioned in the adapter 12 and the upper area of the locking element is positioned within the bore 40. As a result, the locking element 32 no longer blocks the rotor 10 from being pulled upwards and off the adapter 12. During the movement of the locking element 32, the contact point of the locking element 32 on the conical surface 36a of the pressure plate 36 moves linearly in one direction or the other, depending on whether the locking element 32 is being extended out of the adapter 12 or retracted into it.

For example, after replacement of the rotor 10, it is again attached to the adapter 12 with its centric rotor bore 46 adapted to the adapter 12, until the conical area 48 of the rotor 10 makes contact with the support 12a of the adapter 12. The locking element 32 is pressed downwards into the adapter 12 by the conical area 48 and held in this position by the rotor bore 46 until the conical area 48 of the rotor 10 makes contact with the support 12a. The locking bearing 44 is then located slightly below the bore 40 of the adapter 12. The force applied by the spring 38 now allows the locking element 32 to retract linearly into the locking bearing 44 without hindrance far enough to enable the clamping surface 32d of the locking element 32 to make contact with the locking bearing 44. As a result, the rotor 10 is firmly reconnected to the adapter 12 and thus to the drive shaft 14. Should there be manufacturing tolerances, the locking bearing 44 will be higher or lower. As a result, the locking element 32 enters the locking bearing 44 to a greater or lesser extent. In any case, a clearance-free frictional connection is obtained between the locking bearing 44, the locking element 32 and the abutment 40a in the bore 40 of the adapter 12. This ensures that the rotor 10 is securely mounted on the adapter 12 and thus on the drive shaft 14.

This is a simple way of compensating for manufacturing tolerances without causing the rotor 10 to lock with play. Furthermore, because of the inclined position, the centrifugal forces occurring during rotation will only partially affect the locking element 32. Jamming caused by high centrifugal forces is also prevented in this way. This makes for easier manufacturing of the parts, as tolerances can be easily compensated according to the invention.

### LIST OF REFERENCE SIGNS

10 rotor
12 adapter
12a support of adapter 12 for rotor 10
14 drive shaft
18 drive motor
20 sample container receptacle
22 quick-release fastener
24 drive shaft axis of rotation
26 actuating element
26a pushbutton of actuating element 26
26b upper part of actuating element 26
26c lower part of actuating element 26
26d downwardly open bore in actuating element 26
28 bore in adapter 12
28a shoulder in bore 28 in adapter 12
30 stop ring
32 locking element
32a cone at lower end of locking element 32
32b recess in connection to cone 32a of locking element 32
32c guide surface of locking element 32
32d clamping surface of locking element 32, first embodiment
32e recess of locking element 32, second embodiment
34 U-shaped recess
34a transverse area of U-shaped recess 34
34b lateral projection in U-shaped recess 34
36 pressure plate
36a conical surface of pressure plate 36
38 spring acting on actuating element 26
40 bore
40a abutment
42 longitudinal axis of bore 40
44 locking bearing of rotor 10
44a surface of locking bearing 44
46 concentric rotor bore
48 conical area of rotor 10 at lower free end
50 through-hole of rotor 10 for actuating element 26
52 first cone rotor 10/adapter 12
54 second cone adapter 12/drive shaft 14
α first angle
β second angle
H height offset

1-19. (canceled)

20. A centrifuge, comprising
a drive shaft (14) rotatable about an axis of rotation (24),
an adapter (12) connected to the drive shaft (14) or forming part of the drive shaft (14),
a rotor (10) mounted on the adapter (12) and axially removable in a removal direction,
a quick-release fastener (22) acting between the rotor (10) and the adapter (12), whereby the rotor (10) is fixable relative to the adapter (12) in the removal direction and releasable as required,
an abutment (40a) connected to the adapter (12),
a locking bearing (44) connected to the rotor (10),
at least one locking element (32) as part of the quick-release fastener (22), which, when activated, fixes the rotor (10) relative to the adapter (12) and thus to the drive shaft (14) and acts between the locking bearing (44) of the rotor (10) and the abutment (40a) of the drive shaft (14),
wherein the quick-release fastener (22) comprises an actuating element (26), and the locking element (32) is operatively connected to the actuating element (26) in such a way that the actuating element (26) is mounted so as to be movable linearly in parallel to the axis of rotation (24) of the drive shaft (14) between an unlocking position and a locking position, the locking element (32) executes a linear movement relative to the adapter (12) when the actuating element (26) is moved, the locking element (32) is movable at a first angle (α) to the axis of rotation (24) between the locking position and the unlocking position, and the locking bearing (44) is aligned at a second angle (β) to the axis of rotation (24), the second angle (β) is different from the first angle (α), and
wherein the angles (α, β) are measured clockwise from the axis of rotation (24) starting from the side of the actuating element (26) and are between 0° and 90°.

21. The centrifuge according to claim 20, wherein the first angle (α) is in a range of between 20° and 75°, and the second angle (β) is in a range of between 10° and 70°.

22. The centrifuge according to claim 20, wherein the first angle (α) is greater than the second angle (β).

23. The centrifuge according to claim 20, wherein the locking bearing (44) forms a surface (44a) and which, in the locking position, extends as far as the adapter (12), with the surface (44a) of the locking bearing (44) at the adapter (12), in the locking position, having a height offset (H) relative to the locking element (32) projecting from the adapter (12) that is sufficient to enable the locking element (32) to bear against the locking bearing (44) at a radial distance from the adapter (12).

24. The centrifuge according to claim 23, wherein the height offset (H) is greater than the maximum possible manufacturing tolerance of the adjacent surfaces of the adapter (12) and rotor (10) in a direction parallel to the axis of rotation (24).

25. The centrifuge according to claim 20, wherein the actuating element (26) is designed as a cylindrical pin and comprises a receptacle for the one or plural locking element(s) (32) in its lower region.

26. The centrifuge according to claim 25, wherein the actuating element (26) comprises one or more lateral U-shaped recesses (34) for the locking elements (32), which enable the actuating element (26) to move relative to the respective locking element (32) between a locking position and an unlocking position thereof.

27. The centrifuge according to claim 26, wherein the U-shaped recess (34) in the transversely extending region (34a) is designed as an inclined bore which extends at a first angle (α) to the axis of rotation (24).

28. The centrifuge according to claim 20, wherein a pressure plate (36) is provided on the side of the actuating element (26) assigned to the drive shaft (14), with a first contact surface (36a) for the respective locking element (32) being provided on one side of the pressure plate (36) and a second contact surface for a spring (38) being provided on the other side of the pressure plate (36).

29. The centrifuge according to claim 28, wherein the first contact surface (36a) of the pressure plate (36) for the respective locking element (32) is aligned at an angle that is perpendicular to the first angle (α).

30. The centrifuge according to claim 20, wherein the adapter (12) comprises a guide surface for the locking element (32), which is inclined at the first angle (α).

31. The centrifuge according to claim 20, wherein the abutment (40a) is part of the adapter (12) and aligned at the first angle (α).

32. The centrifuge according to claim 20, wherein the actuating element (26), the locking element (32), or both, is spring-loaded in the direction of the locking position.

33. The centrifuge according to claim 20, wherein a plurality of blocking elements (32) are provided, with each blocking element (32) being formed identically to the other.

34. The centrifuge according to claim 33, wherein the blocking elements (32) are arranged equidistant from one another.

35. The centrifuge according to claim 20, wherein the locking element (32) is designed throughout as an elongated pin, which is cylindrical in its basic shape.

36. The centrifuge according to claim 35, wherein the locking element (32) comprises recesses (32b, 32e) made therein, the recesses (32b, 32e) interact with projections (34b) of the adapter (12) to provide anti-rotation protection as it moves from its locking position to its unlocking position.

37. The centrifuge according to claim 20, wherein the locking element (32) comprises at its front end an inclined surface (32d) relative to its longitudinal axis, which in the locking position rests against the locking bearing (44).

38. The centrifuge according to claim 20, wherein the locking element is mounted in the adapter in a way that the longitudinal axis of the locking element (32) intersects the axis of rotation (24).
